(19) United States
(12) Patent Application Publication
(10) Pub. No.: US 2007/0011621 A1
(43) Pub. Date: Jan. 11, 2007

(54) Methods and systems of graphical user interface presentation

(75) Inventor: Po-Sheng Hsu, Taipei (TW)

Correspondence Address: QUINTERO LAW OFFICE, 1617 BROADWAY, 3RD FLOOR, SANTA MONICA, CA, 90404, US

(73) Assignee: LITE-ON TECHNOLOGY CORPORATION, TAIPEI (TW)

(21) Appl. No.: 11/441,619

(22) Filed: May 26, 2006

(30) Foreign Application Priority Data
Jul. 6, 2005 (TW) TW94122849

(51) Int. Cl. G06F 3/00

(52) U.S. Cl. 715/762

(57) ABSTRACT

Methods and systems for graphical user interface (GUI) presentation. First, an application comprising a GUI is executed. The application triggers an analyzer analyzing a description file depicting attributes of components of the GUI. The analyzer provides and stores the attributes in a data structure. When a GUI component is to be displayed, the application utilizes a standardized control interface independent of various display drivers to display the GUI component according to the stored attributes.

### BACKGROUND

The invention relates to computer techniques, and in particular, to methods and computers for presenting graphical user interface.

In programming, a graphical user interface (GUI) is typically composed by combining an application program interface (API) of an operating system (OS) with text data. The combination of GUI attributes and different language text into computer programs may affect program runtime efficiency and readability, and make maintenance thereof difficult. For example, after a program is compiled, any change of text data therein requires compiling the program again, which is very inconvenient. Additionally, different OSs provide different APIs, so GUI code executable on one OS may not be compatible with another OS, thus, requiring modification to conforming to the API of the latter OS.

### SUMMARY

Accordingly, methods and systems of graphical user interface presentation are provided.

An exemplary embodiment of a method of graphical user interface (GUI) presentation is implemented in an embedded system comprising a display, a driver controlling the display, an application, an analyzer, a description file, and a portable layer providing a standard interface for different display drivers. The application comprising a GUI is executed. The application triggers the analyzer analyzing the description file depicting attributes of components of the GUI. The analyzer provides the attributes subsequently stored in a data structure. When a GUI component is to be displayed, the application issues a first instruction conforming to the standard interface for displaying the GUI component according to the stored attributes. The portable layer provides a second instruction conforming to the driver of the display according to the first instruction. The driver displays the GUI component on the display according to the second instruction and attributes of the GUI component.

An exemplary embodiment of an embedded system comprises a display, a driver controlling the display, an application, a description file, an analyzer, and a portable layer. The application comprises a GUI. The description file depicts attributes of components of the GUI. The application triggers the analyzer analyzing the description file to provide the attributes subsequently stored in a data structure. When a GUI component is to be displayed, the application provides a first instruction conforming to a standard interface for displaying the GUI component according to the stored attributes. The portable layer provides the standard interface for different display drivers and issues a second instruction conforming to the driver of the display according to the first instruction. The driver displays the GUI component on the display according to the second instruction and attributes of the GUI component.

### DESCRIPTION OF THE DRAWINGS

The invention can be more fully understood by reading the subsequent detailed description and examples with references made to the accompanying drawings, wherein:

FIG. 1 is a block diagram of an exemplary embodiment of an embedded system;

FIG. 2 is flowchart of an exemplary embodiment of a method for Graphical User Interface;

FIG. 3 is a schematic diagram of a description file;

FIG. 4 is a schematic diagram of a language file;

FIG. 5 is a schematic view of GUI components displayed on a display based on attributes of the description file in FIG. 3 and the language file in FIG. 4;

FIG. 6 is a schematic diagram of a description file;

FIG. 7 is a schematic diagram of a language file; and

FIG. 8 is a schematic view of GUI components displayed on a display based on attributes of the description file in FIG. 6 and the language file in FIG. 7.

### DETAILED DESCRIPTION

Methods and systems of graphical user interface presentation are provided. The methods for graphical user interface can be implemented in embedded systems, such as mobile phones, Personal Digital Assistants (PDAs), and video game consoles.

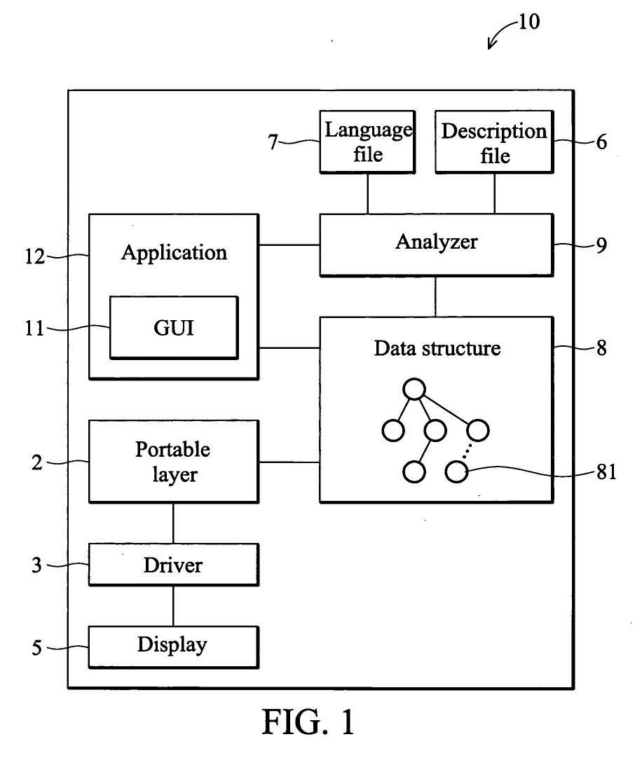

In FIG. 1, a method for graphical user interface is implemented in embedded system 10. Portable layer 2, driver 3 controlling display 5, and analyzer 9 may be implemented by computer programs or electrical circuits. Application 12 comprising GUI 11 can generate components of GUI 11 in various execution statuses and reflect operations on the GUI components. Generation of GUI components is described later.

Description file 6 and language file 7 are two different files external to application 12 and may conform to extensible markup language (XML) or other formats analyzable by analyzer 9. Description file 6 depicts attributes of components of GUI 11. Portable layer 2 provides a standard interface for different display drivers.

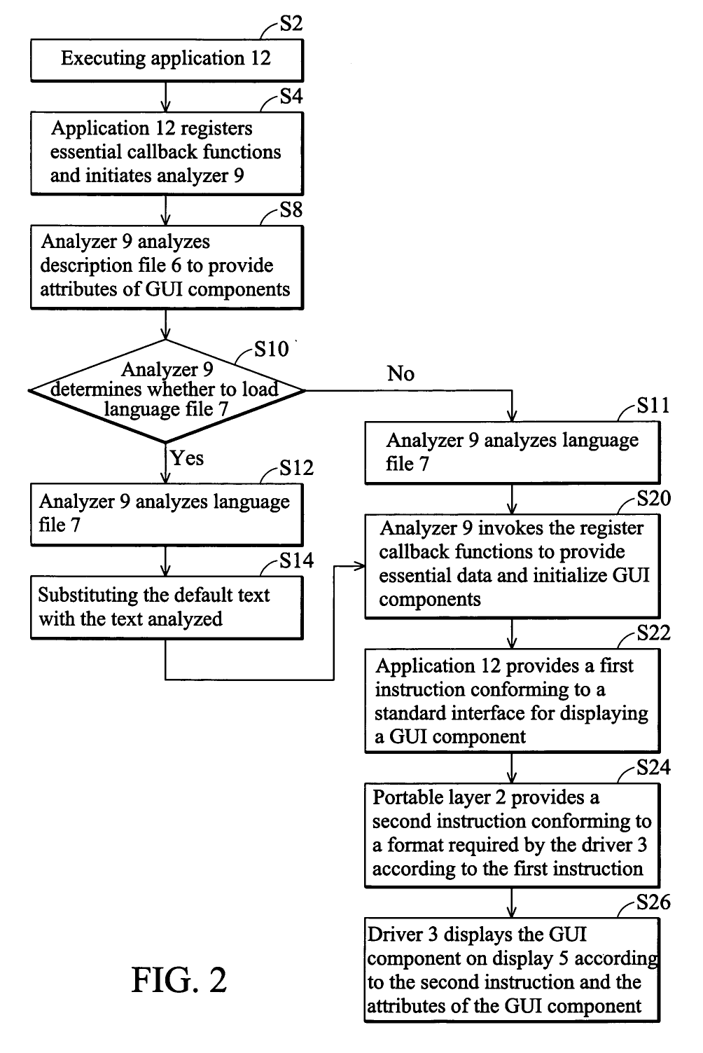

With reference to FIG. 2, a processor of embedded system 10 executes application 12 (step S2). Application 12 registers essential callback function for subsequent invocation by analyzer 9 and initiates analyzer 9 (step S4).

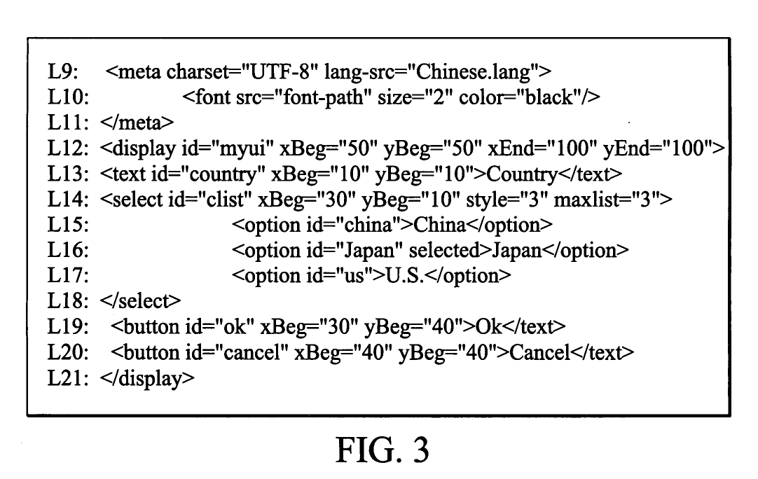

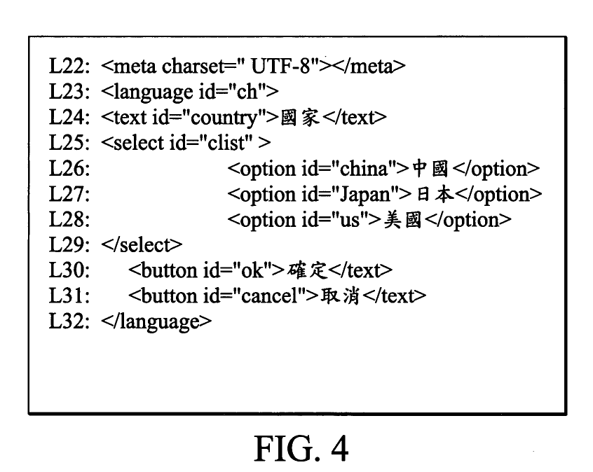

Analyzer 9 analyzes description file 6 to provide attributes of the GUI components (step S8). The attributes are subsequently stored in data structure 8 which may comprise a tree data structure. Description file 6 comprises default text of the GUI components, such as “Country”, “China”, “Japan”, “U.S.”, “OK”, and “Cancel” enclosed by tags in FIG. 3. Language file 7 comprises text for substituting the default text, such as Chinese characters in FIG. 4. The text in language file 7 and the default text may respectively belong to different languages.

FIGS. 3 and 4 show a description file and a language file conforming to XML, wherein the tags therein are defined in advance. In row L9, <meta> depicts common attributes of description file 6. For example, [charset=“UTF-8”] states that the description file is encoded with Universal Transformation Format 8 bit (UTF-8) encoding scheme. [lang-src=“Chinese.lang”] represents that content, Chinese.lang of FIG. 4, is to be imported. The font type, size, and text color of the GUI components are to conform to the definition in row L10, except for those individually defined in the description file. The <display> tag in row L12 depicts attributes of the GUI components. For example, configuration attributes [xBeg=“50” yBeg=“50” xEnd=“100” yEnd=“100”] indicate boundary coordinates of the GUI components, which may be relative or absolute coordinates. The <text>, <select>, and <button> tags respectively depict text, list, and button components, wherein configuration attributes thereof may be included. For example, a <text> tag comprises [xBeg=“10” yBeg=“10”]; a <select> tag comprises [style=“3” maxlist=“3”] indicating a list style and the number of options in a list.

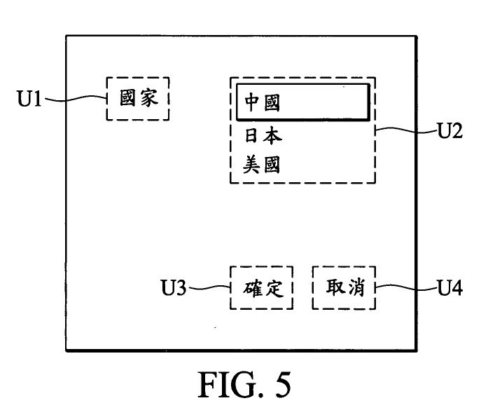

The <language> tag in FIG. 4 indicates a language type. Analyzer 9 determines whether to load language file 7 (step S10). If so, analyzer 9 analyzes language file 7 (step S12) and substitutes the default text with the text analyzed (step S14). For example, analyzer 9 can locate text of other language in language file 7 to substitute for the default text in description file 6 according to [id] in FIGS. 3 and 4. If not, analyzer 9 analyzes language file 7 (step S11) and description file 6 continuously. When the analysis is complete, analyzer 9 stores the analysis results in data structure 8 and may invoke the register callback functions to provide essential data and initialize GUI components (step S20). For example, attributes of list U2 in FIG. 5 are described in row L14-L18 of FIG. 3 and row L24-L29 in FIG. 4 and stored as attributes 81 in data structure 8.

When a GUI component (such as list U2) of application 12 is to be displayed, application 12 provides a first instruction conforming to the standard interface for displaying the GUI component according to the stored attributes (such as attributes 81 corresponding to row L14-L18 of FIG. 3 and row L24-L29 in FIG. 4) (step S22).

Portable layer 2 provides a second instruction conforming to a format required by the driver 3 according to the first instruction (step S24). Since portable layer 2 provides a standard interface for different display drivers, the GUI codes of application 12 for displaying GUI 11 are compatible with those of different display drivers.

After receiving the second instruction, driver 3 displays the GUI component (such as list U2) on display 5 according to the second instruction and the attributes (such as attributes 81) of the GUI component (step S26).

As shown in FIG. 5, GUI components are displayed on display 5 based on attributes of the description file in FIG. 3 and the language file in FIG. 4. Text component U1 corresponds to <text> tags with [id] attributes of “country” in the description file in FIG. 3 and the language file in FIG. 4 (in rows L13 and L24), and the default text “Country” of text component U1 has been replaced by Chinese characters. GUI components U1-U4 are respectively text, list, and two button components, the layout attributes of which are based on corresponding tags (in rows L13-L20), and the default text of which is replaced by text in the corresponding tags (in rows L24-L31).

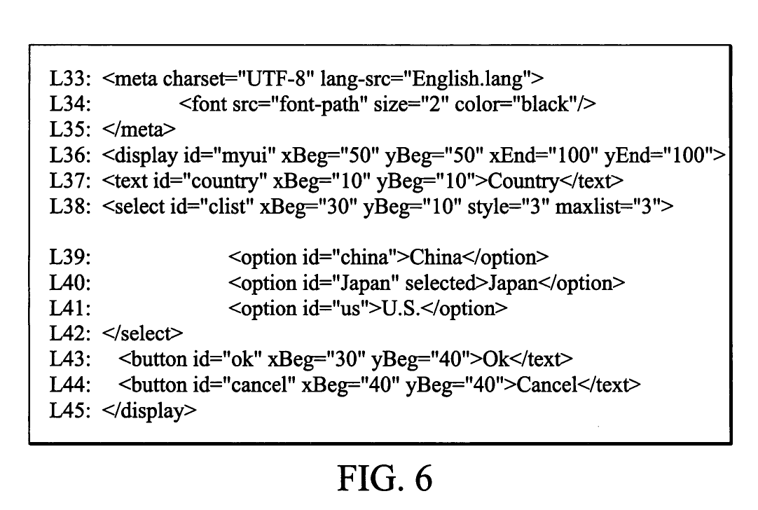

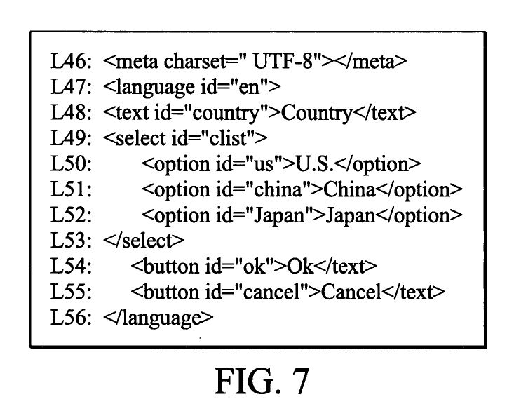

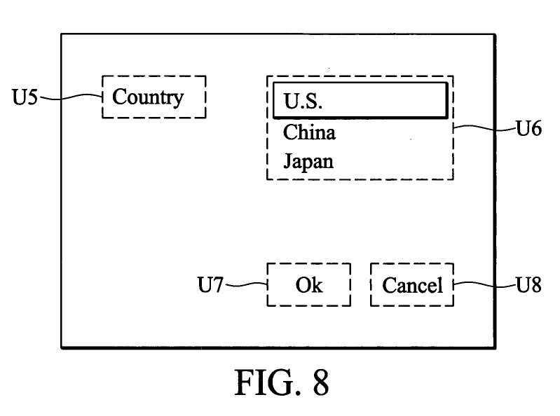

The layout of GUI components may be adjusted according to the selected country without re-compiling application 12. When the description file of FIG. 3 is modified to FIG. 6, GUI components are displayed on display 5 based on attributes of the description file in FIG. 6 and the language file of FIG. 7, as shown in FIG. 8. In FIG. 6, [lang-src=“English.lang”] in row L33 indicates that English.lang of FIG. 7 is to be imported. The layout of GUI components U5-U8 is based on corresponding tags (in rows L37-L44), the default text of which is replaced by text in the corresponding tags (in rows L48-L55). The order of options (rows L49-L53) following the <select> tag in FIG. 7 (the language file) is different from the order of options (rows L38-L42) following the <select> tag in FIG. 6 (the description file). Thus, after the options and the text in the language file replace the options and the text in the description file, GUI component U6 is displayed based on the option order in the language file, the text of which is English.

Thus, a description file can be modified to change appearance of GUI components without re-compiling an application program. Moreover, a portable layer can be modified to enable execution of the application on different OSs without rewriting.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for graphical user interface (GUI), implemented in an embedded system comprising a display, a driver controlling the display, an application, an analyzer, a description file, and a portable layer providing a standard interface for different drivers, comprising:
executing the application comprising a GUI;
triggering by the application, of the analyzer analyzing the description file depicting attributes of components of the GUI;
provision by the analyzer, of the attributes subsequently stored in a data structure;
when a GUI component is to be displayed, provision by the application of a first instruction conforming to the standard interface for displaying the GUI component according to the stored attributes;
provision by the portable layer, of a second instruction conforming to the driver of the display according to the first instruction; and
displaying of the GUI component on the display by the driver according to the second instruction and attributes of the GUI component.

2. The method as claimed in claim 1, wherein the data structure comprises a tree data structure.

3. The method as claimed in claim 1, wherein the description file conforms to extensible markup language (XML).

4. The method as claimed in claim 1, wherein the embedded system further comprises a language file comprising text data of the GUI component, and the analyzer analyzes the language file.

5. The method as claimed in claim 4, wherein the description file comprises default text of the GUI component, the description file and the language file storing a relationship between the default text and the text data stored in the language file for substituting the default text.

6. The method as claimed in claim 4, wherein the default text in and the text data stored in the language file are respectively written in different languages.

7. An embedded system, comprising:
a display;
a driver controlling the display;
an application comprising a GUI;
a description file depicting attributes of components of the GUI;
an analyzer triggered by the application, analyzing the description file to provide the attributes subsequently stored in a data structure, wherein, when a GUI component is to be displayed, the application provides a first instruction conforming to a standard interface for displaying the GUI component according to the stored attributes; and
a portable layer providing the standard interface for different drivers, providing a second instruction conforming to the driver of the display according to the first instruction, wherein the driver displays the GUI component on the display according to the second instruction and attributes of the GUI component.

8. The embedded system as claimed in claim 7, wherein the data structure comprises a tree data structure.

9. The embedded system as claimed in claim 7, wherein the description file conforms to extensible markup language (XML).

10. The embedded system as claimed in claim 7, wherein the embedded system further comprises a language file comprising text data of the GUI component, and the analyzer analyzes the language file.

11. The embedded system as claimed in claim 10, wherein the description file comprises default text of the GUI component, the description file and the language file store a relationship between the default text and the text data stored in the language file for substituting the default text.

12. The embedded system as claimed in claim 10, wherein the default text and the text data stored in the language file are respectively written in different languages.
